(19) United States
(12) Patent Application Publication
(10) Pub. No.: US 2026/0015522 A1
(43) Pub. Date: Jan. 15, 2026

(54) EPOXY CURED POLYURETHANES AND ADDITIVE MANUFACTURING METHODS USING SAME

(71) Applicant: Carbon, Inc., Redwood City, CA (US)

(72) Inventor: R. Nicholas Carmean, Mountain View, CA (US)

(21) Appl. No.: 19/268,364

(22) Filed: Jul. 14, 2025

Related U.S. Application Data
(60) Provisional application No. 63/671,431, filed on Jul. 15, 2024.

(51) Int. Cl. C09D 175/14; B29C 64/124; B29C 64/188; B29K 71/00; B29K 75/00; B33Y 10/00; B33Y 40/20; C08G 18/32; C08G 18/50; C08G 18/66; C08G 18/80

(52) U.S. Cl. CPC C09D 175/14; B29C 64/124; B29C 64/188; B33Y 10/00; B33Y 40/20; C08G 18/3218; C08G 18/5024; C08G 18/6681; C08G 18/808; B29K 2071/00; B29K 2075/00; B29K 2995/0077

(57) ABSTRACT

Provided are methods of forming a three-dimensional object that include irradiating a resin composition of the invention with actinic radiation or light, thereby forming a three-dimensional intermediate, and then further reacting the three-dimensional intermediate to form the three-dimensional object. In some embodiments, resin compositions of the invention include a polyisocyanate such as, e.g., a reactive blocked polyisocyanate; a polyfunctional epoxy compound; a photoinitiator; optionally, a catalyst; optionally, a polyol and/or a polyamine chain extender; optionally, a reactive diluent; optionally, a pigment or dye; and optionally, a filler. Related resin compositions are also provided herein. Further, provided are three-dimensional objects formed by a method of the invention, including, e.g., objects formed of a polymer having at least one oxazolidinone linkage.

### CROSS REFERENCE TO RELATED APPLICATIONS

This application claims the benefit of U.S. Provisional Application No. 63/671,431, filed Jul. 15, 2024, the contents of which is hereby incorporated by reference in its entirety.

### FIELD OF THE INVENTION

The present invention relates to resins and methods of additive manufacturing. In particular, the present invention relates to polyurethane resins for use in additive manufacturing.

### BACKGROUND OF THE INVENTION

A group of additive manufacturing techniques sometimes referred to as “stereolithography” creates a three-dimensional object by the sequential polymerization of a light polymerizable resin. Such techniques may be “bottom-up” techniques, where light is projected into the resin on the bottom of the growing object through a light transmissive window, or “top-down” techniques, where light is projected onto the resin on top of the growing object, which is then immersed downward into the pool of resin.

The introduction of a more rapid stereolithography technique known as continuous liquid interface production (CLIP) has expanded the usefulness of stereolithography from prototyping to manufacturing. See, e.g., U.S. Pat. Nos. 9,211,678, 9,205,601, and 9,216,546; and also J. Tumbleston, D. Shirvanyants, N. Ermoshkin et al., Continuous liquid interface production of 3D Objects, Science 347, 1349-1352 (2015).

(Meth)acrylate blocked polyurethanes and polyureas are known and have been used in additive manufacturing. See, e.g., U.S. Pat. Nos. 9,453,142, 9,982,164, and 10,647,880. Traditionally, more rigid reactive blocked polyurethanes and/or polyureas are achieved by increasing isocyanate concentration. However, this may also increase the concentration of the reactive blocking agent. A commonly used reactive blocking agent, tert-butylaminoetbyl methacrylate (TBAEMA), is suspected to lead to unwanted side reactions, which can limit thermal performance. Compounds such as TBAEMA may also be water soluble, so their properties can be sensitive to humidity. Therefore, new methods of making reactive blocked polyurethanes would be desirable.

### SUMMARY OF THE INVENTION

Provided according to embodiments of the invention are methods of forming a three-dimensional object that include irradiating a resin composition of the invention with actinic radiation or light, thereby forming a three-dimensional intermediate, and then further reacting the three-dimensional intermediate to form the three-dimensional object. In some embodiments, resin compositions of the invention include (a) a reactive blocked polyisocyanate; (b) a polyfunctional epoxy compound; (c) a photoinitiator; (d) optionally, a polyol and/or a polyamine; (e) optionally, a reactive diluent; (f) optionally, a pigment or dye; and (g) optionally, a filler. In some embodiments, resin compositions of the invention include (a) a polyisocyanate; (b) a polyfunctional epoxy compound; (c) a photoinitiator; (d) a catalyst; (e) optionally, a polyol and/or a polyamine; (f) optionally, a reactive diluent; (g) optionally, a pigment or dye; and (h) optionally, a filler.

In some embodiments, the polyisocyanate (e.g., reactive blocked polyisocyanate) includes at least one ether linkage, at least one urethane linkage, and/or at least one urea linkage. In some embodiments, a reactive blocked polyisocyanate is blocked with a secondary amine or tertiary amine (e.g., a hindered secondary amine acrylate and/or hindered secondary amine methacrylate).

In some embodiments, the polyfunctional epoxy compound is an end-functionalized compound (e.g., bisphenol A diglycidyl ether, neopentyl glycol diglycidyl ether, polyethyene glycol diglycidyl ether, N,N,N′,N′-tetraglycidyl-m-xylenediamine) and/or a compound with an epoxy group within the backbone and/or pendent from a polymeric chain (e.g., novolac multifunctional epoxy, polybutadiene functionalized epoxy).

In some embodiments, the method comprises:
(a) providing a carrier and an optically transparent member having a build surface, the carrier and the build surface defining a build region therebetween;
(b) filling the build region with the resin composition;
(c) irradiating the build region with actinic radiation or light through the optically transparent member to solidify at least a portion of the resin composition;
(d) advancing the carrier away from the build surface;
(e) repeating steps (b) through (d) to form a solid polymer scaffold that is a three-dimensional intermediate having the same shape as, or a shape to be imparted to, the three-dimensional object;
(f) optionally, washing the three-dimensional intermediate; and
(g) further reacting the three-dimensional intermediate to form the three-dimensional object.

Also provided according to embodiments of the invention are three-dimensional objects formed by a method of the invention. In some embodiments, the three-dimensional objects include an oxazolidinone linkage.

### BRIEF DESCRIPTION OF THE DRAWINGS

FIG. 1 illustrates a mechanism for the reaction of an isocyanate with an epoxy. R¹ and R³ are each independently alkyl groups, including but not limited to, ethyl(ene), propyl(ene), butyl(ene), tert-butyl phenyl(ene), cyclohexyl(ene), and/or a UV reactive group including, but not limited to, vinyl, acrylate or methacrylate. R² is the remaining portion of the polyisocyanate chain. R⁴ is the remaining portion of the polyfunctional epoxy compound.

### DETAILED DESCRIPTION OF ILLUSTRATIVE EMBODIMENTS

The present invention is now described more fully hereinafter with reference to particular embodiments. This invention may, however, be embodied in many different forms and should not be construed as limited to the embodiments set forth herein; rather, these embodiments are provided so that this disclosure will be thorough and complete and will fully convey the scope of the invention to those skilled in the art.

The terminology used herein is for the purpose of describing the particular embodiments only and is not intended to be limiting of the invention. As used herein, the singular forms “a,” “an” and “the” are intended to include plural forms as well, unless the context clearly indicates otherwise.

It will be further understood that the terms “comprises” or “comprising,” when used in this specification, specify the presence of stated features, integers, steps, operations, elements components and/or groups or combinations thereof, but do not preclude the presence of addition of one or more other features, integers, steps, operations, elements, components and/or groups or combinations thereof. The sequence of operations (or steps) is not limited to the order presented in the claims or figures unless specifically indicated otherwise. Any element that comprises certain features, integers, steps, operations, elements, components and/or groups may also “consist of” or “consist essentially of” such features, integers, steps, operations, elements, components and/or groups, respectively.

As used herein, the term “and/or” includes any and all possible combinations of one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein.

It will be understood that, although the terms first, second, etc. (or the use of “additional”) may be used herein to describe various elements or components, these elements and components, should not be limited by these terms. Rather, these terms are only used to distinguish one element or component from another element or component. Thus, a first element or component could be termed a second element or component without departing from the teachings of the present invention,

“Shape to be imparted to” refers to the case where the shape of the intermediate object slightly changes between formation thereof and forming the subsequent three-dimensional product, typically by shrinkage (e.g., up to 1, 2 or 4 percent by volume), expansion (e.g., up to 1, 2 or 4 percent by volume), removal of support structures, or by intervening forming steps (e.g., intentional bending, stretching, drilling, grinding, cutting, polishing, or other intentional forming after formation of the intermediate product, but before formation of the subsequent three-dimensional product). The three-dimensional intermediate may also be washed, if desired, before further curing, and/or before, during, or after any intervening forming steps.

All publications and patents cited herein are specifically incorporated by reference to disclose the methods and/or materials with which the documents are cited.

As used herein, the term “about” with reference to a numerical number or range refers to the exact numbers and to values that are +/−1%, 2%, 5%, or 10% thereof. It is also to be understood that where a range of values is provided, each intervening integer within the upper and lower limit of the range is also explicitly disclosed.

Provided according to embodiments of the invention are methods of forming a three-dimensional object that include irradiating a resin composition (also referred to as a “polymerizable liquid” herein) of the invention with actinic radiation or light, thereby forming a three-dimensional intermediate, and then further reacting the three-dimensional intermediate to form the three-dimensional object. In some embodiments, resin compositions of the invention include (a) a polyisocyanate such as, e.g., a reactive blocked polyisocyanate; (b) a polyfunctional epoxy compound; (c) a photoinitiator; (d) optionally, a catalyst, (e) optionally, a polyol and/or a polyamine chain extender; (f) optionally, a reactive diluent; (g) optionally, a pigment or dye; and (h) optionally, a filler.

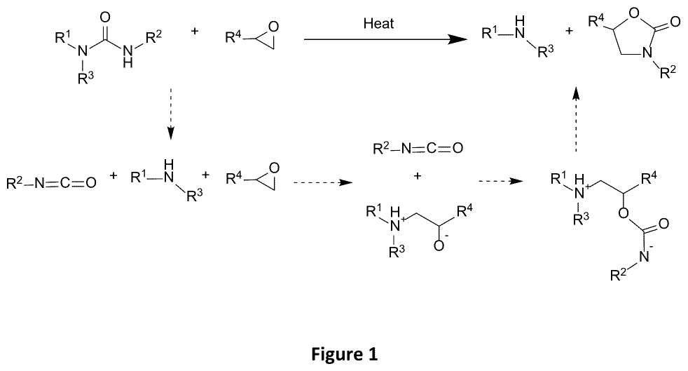

Isocyanates may react with epoxy compounds to produce oxazolidinones (also referred to as oxaziladones) at high temperatures (140° C.) with a catalyst. As shown in FIG. 1, secondary amines (e.g., hindered secondary amines) such as TBAEMA or tertiary amines may catalyze the cyclization that leads to oxazolidinone formation. Accordingly, for a polyisocyanate blocked with a secondary (e.g., hindered secondary) amine or tertiary amine, once the polyisocyanate becomes deblocked (e.g., during a heating step in a dual cure manufacturing process), the free hindered secondary or tertiary amine may catalyze the formation of the reaction of the polyisocyanates with the polyfunctional epoxy, thereby forming oxazolidinones and chain extending the polyisocyanate. One advantage of using this process is that there are many commercially available polyfunctional epoxies, and thus, the properties of the final three-dimensional object may be modified based on the polyfunctional epoxy used. In addition, the epoxy-NCO reaction is latent when the polyisocyanates are blocked, so the resin compositions may have a relatively long pot life in two-part systems or may be useful as single part resins.

### Resin Compositions

In some embodiments, resin compositions of the invention include (a) a reactive blocked polyisocyanate; (b) a polyfunctional epoxy compound; (c) a photoinitiator; (d) optionally, a catalyst, (e) optionally, a polyol and/or a polyamine chain extender; (f) optionally, a reactive diluent; (g) optionally, a pigment or dye; and (h) optionally, a filler. In such resin compositions, the polyisocyanate may optionally be blocked with a blocking group that, once deblocked from the polyisocyanate, forms a compound that catalyzes the reaction of the polyisocyanate with the polyfunctional epoxy compound to form an oxazolidinone.

In some of such embodiments, the reactive blocked polyisocyanate is polymerized by the with actinic radiation or light (in combination with the photoinitiator) in a first curing step (e.g., during the formation of the three-dimensional intermediate), the reactive blocked polyisocyanate is deblocked to provide a catalyst for oxazolidinone formation and the polyfunctional epoxy compound reacts with the polyisocyanate in a second or subsequent curing step in the presence of this catalyst. In other embodiments, the resin composition includes (a) a polyisocyanate; (b) a polyfunctional epoxy compound; (c) a photoinitiator; (d) a catalyst; (e) optionally, a polyol and/or a polyamine; (f) optionally, a reactive diluent; (g) optionally, a pigment or dye; and (h) optionally, a filler. In such cases, the polyisocyanate need not be blocked or reactively blocked, as the catalyst for the reaction of the polyisocyanate with the polyfunctional epoxy compound is separately included in the resin. Although in some embodiments, the polyisocyanate is not blocked, in other embodiments, some of all of the polyisocyanate may be blocked with a non-reactive blocking group and/or may be blocked with a reactive blocking group that does not form a catalyst for the reaction of the polyisocyanate with the polyfunctional epoxy compound.

In some embodiments, the reactive diluent is polymerized by the with actinic radiation or light (in combination with the photoinitiator) in a first curing step to form a three-dimensional intermediate and the polyfunctional epoxy compound reacts with the polyisocyanate (in the presence of a catalyst included in the resin) to form oxazolidinone linkages in a second curing step. In other embodiments, a group that reacts with actinic radiation or light (a UV reactive group) may be attached to the polyisocyanate, and the polyisocyanate can react in the first curing step, alternatively or additionally to the reactive diluent.

### Polyisocyanates

A number of possible polyisocyanates, including reactive blocked polyisocyanates, may be used in embodiments of the invention. Examples include, but are not limited to, those described in U.S. Pat. Nos. 9,453,142, 9,982,164, and 10,647,880, the contents of each of which are hereby incorporated by reference in their entirety. Herein, “diisocyanate” and “polyisocyanate” may be used interchangeably and refer to aliphatic, cycloaliphatic, and aromatic isocyanates that have at least 2, or in some embodiments more than 2, isocyanate (NCO) groups per molecule, on average. In some embodiments, the isocyanates have, on average, 3 to 6, 8 or 10 or more isocyanate groups per molecule. In some embodiments, the isocyanates may be a hyperbranched or dendrimeric isocyanate (e.g., containing more than 10 isocyanate groups per molecule, on average). Combinations of polyisocyanates may be used in some embodiments.

Common examples of suitable isocyanates include, but are not limited to, methylene diphenyl diisocyanate (MDI), toluene diisocyanate (TDI)), para-phenyl diisocyanate (PPDI), 4,4′-dicyclohexylmethane-diisocyanate (HMDI), hexamethylene diisocyanate (HDI), isophorone diisocyanate (IPDI), triphenylmethane-4,4′4″-triisocyanate, tolune-2,4,6-triyl triisocyanate, 1,3,5-triazine-2,4,6-triisocyanate, ethyl ester L-lysine triisocyanate, etc., including combinations thereof. Numerous additional examples are known and are described in, for example, U.S. Pat. Nos. 9,200,108, 8,378,053, 7,144,955, 4,075,151, 3,932,342, and in U.S. Patent Application Publication Nos. US 20040067318 and US 20140371406, the disclosures of all of which are incorporated by reference herein in their entirety.

In some embodiments, a reactive blocked polyisocyanate is blocked by reaction of a polyisocyanate with a secondary (e.g., hindered secondary) amine or tertiary amine, such as a hindered secondary or tertiary amine acrylate or methacrylate. In some embodiments, the amine is a (meth)acrylate monomer blocking agent (e.g., tertiary-butylaminoethyl methacrylate (TBAEMA), tertiary pentylaminoethyl methacrylate (TPAEMA), tertiary hexylaminoethyl methacrylate (THAEMA), tertiary-butylaminopropyl methacrylate (TBAPMA), acrylate analogs thereof, and mixtures thereof (see, e.g., US Patent Application Publication No. 20130202392)). Note that, in some embodiments, one or more of these blocking agents may be included in the resin composition as a reactive diluent.

In some embodiments, the polyisocyanates may also be blocked with other groups, including non-reactive groups. Blocking agents are known in the art and include, e.g., those described in U.S. Pat. No. 9,676,963, the contents of which are herein incorporated by reference in their entirety.

In some embodiments, the reactive blocked polyisocyanate comprises a compound of the formula A—X—A, where X is a hydrocarbyl group and each A is an independently selected substituent of Formula X:

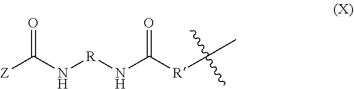

where R is a hydrocarbyl group, R′ is O or NH, and Z is a blocking group, the blocking group optionally having a reactive terminal group (e.g., a polymerizable end group such as an epoxy, alkene, alkyne, or thiol end group, for example an ethylenically unsaturated end group such as a vinyl ether). In a particular example, each A is an independently selected substituent of Formula (XI):

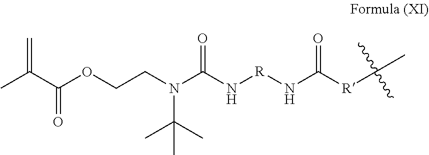

where R and R′ are as given above.

In some embodiments, a reactive blocked polyisocyanate comprises a polyisocyanate oligomer produced by the reaction of at least one diisocyanate (e.g., a diisocyanate such as hexamethylene diisocyanate (HDI), bis-(4-isocyanatocyclohexyl)methane (HMDI), isophorone diisocyanate (IPDI), etc., a triisocyanate, etc.) with at least one polyol (e.g., a polyether or polyester or polybutadiene diol).

In some embodiments, the polyisocyanate (e.g., the reactive blocked polyisocyanate) comprises at least one ether linkage, at least one urethane linkage, and/or at least one urea linkage.

The concentration of the polyisocyanate may vary depending on the polyfunctional isocyanate and the desired properties of three-dimensional object to be formed. However, in some embodiments, the polyisocyanate is present in the resin composition at a concentration in a range of 20 weight percent to 80 weight percent.

### Polyfunctional Epoxy Compound

A “polyfunctional epoxy compound” refers to an aliphatic, cycloaliphatic, and aromatic compound that has at least 2, or in some embodiments more than 2, epoxy groups per molecule, on average. In some embodiments, the polyfunctional epoxy compound is a diepoxy compound. In some embodiments, the polyfunctional epoxy compound is an end-functionalized compound, including but not limited to bisphenol A diglycidyl ether, neopentyl glycol diglycidyl ether, polyethyene glycol diglycidyl ether, N,N,N′,N′-tetraglycidyl-m-xylenediamine, and the like. In some embodiments, the polyfunctional epoxy compound includes one or more epoxy groups within or pendant from the polymer backbone. Combination of different polyfunctional epoxy compounds may also be used. Examples include, but are not limited to, a novolac multifunctional epoxy, and a polybutadiene functionalized epoxy. Particular polyfunctional epoxy compounds include the following compounds:

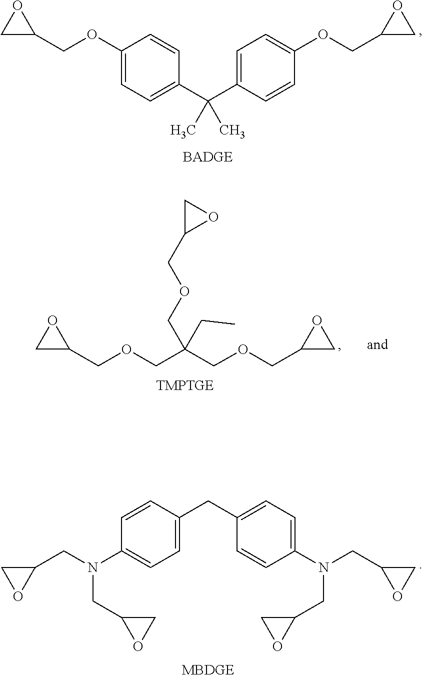 [SMILES: CC(C)(c1ccc(OCC2CO2)cc1)c1ccc(OCC2CO2)cc1 ; CCC(COCC1CO1)(COCC1CO1)COCC1CO1 ; c1cc(N(CC2CO2)CC2CO2)ccc1Cc1ccc(N(CC2CO2)CC2CO2)cc1]

The concentration of the polyfunctional epoxy compound(s) may vary depending on the polyfunctional epoxy compound and the desired properties of three-dimensional object to be formed. However, in some embodiments, the polyfunctional epoxy compound is present in the resin composition at a concentration in a range of 5 weight percent to 70 weight percent.

### Photoinitiators

Any suitable photoinitiator may be included in the resin compositions of the present invention. In some embodiments, the photoinitiator is a free radical photoinitiator. “Free radical photoinitiator” as used herein includes type I free radical photoinitiators, such as phosphineoxide (TPO) or hydroxyacetophenone (HAP), and/or type II free radical photoinitiators, such as a benzophenone photoinitiator (optionally but preferably in combination with a co-initiator (e.g., an alcohol or amine)). Particular examples include, but are not limited to, diphenyl(2,4,6-trimethylbenzoyl)phosphine oxide (TPO), diphenylphosphinyl(2,4,6-trimethylphenyl methanone; benzophenone; substituted benzophenones; acetophenone; substituted acetophenones; benzoin; benzoin alkyl esters; xanthone; substituted xanthones; diethoxy-acetophenone; benzoin methyl ether; benzoin ethyl ether; benzoin isopropyl ether; diethoxyxanthone; chloro-thio-xanthone; N-methyl diethanol-amine-benzophenone; 2-hydroxy-2-methyl-1-phenyl-propan-1-one; 2-benzyl-2-(dimethylamino)-1-[4-(4-morpholinyl)phenyl]-1-butanone; 2-isopropylthioxanthone (ITX); and mixtures thereof. See, e.g., U.S. Pat. No. 9,090,765 for additional photoinitiator examples. Combinations of photoinitiators may be used.

The amount of photoinitiator in the resin composition may vary but in some embodiments of the invention, the photoinitiator is present in the polymerizable liquid at a concentration of from about 0.05% to about 10% by weight, including about 0.05%, about 0.1%, about 0.5%, about 1%, about 2%, about 3%, about 4%, about 5%, about 6%, about 7%, about 8%, about 9%, about 10% by weight, or a range defined between any two of the foregoing values.

### Catalysts

In some embodiments, the resin compositions include one or more compounds that catalyze the reaction of the polyisocyanate(s) with the polyfunctional epoxy compound(s). In some embodiments, the resin is devoid of any added catalyst beyond the blocking group (e.g., devoid of a secondary or tertiary amine) that is used to block the polyisocyanate. However, in some embodiments, an additional catalyst is added to the resin composition. Secondary (e.g., hindered secondary) amines and tertiary amines may be used as such catalysts. In some embodiments, other compound(s) that catalyze the cyclization of the polyisocyanate and the polyfunctional epoxy to form an oxaziladone may be used. Examples include, but are not limited, to 2-phenyl imidazole, phosphines, ammonium and phosphonium salts, Lewis acids (e.g., those containing a halide anion), tetrabutylphosphonium bromide or iodide, and bis-tetraphenylphosphonium carbonate. Combinations of catalysts may be used in some embodiments.

### Polyol and Polyamine Chain Extenders

Although in some embodiments, the resin composition is devoid of polyol, polyamine, and/or polythiol chain extenders (excluding an optional amine used to block the polyisocyanate), in some embodiments, the resin compositions include free polyol, polyamine, and/or polythiol compounds to further act as a chain extender. Herein, a “polyol,” “polyamine,” or “polythiol” refers to aliphatic, cycloaliphatic, and aromatic polyols, polyamines, or polythiols, respectively, that have at least 2, or in some embodiments more than 2, alcohol, amine (including primary, secondary or tertiary amines), or thiol, respectively, groups per molecule, on average. In some embodiments, the polyol and/or polyamine chain extender comprises at least one diol and/or diamine (e.g., ethylene glycol, 1,3-propanediol, 1,2-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,2-cyclohexanedimethanol, 1,4-cyclohexanedimethanol, the corresponding diamine, lysine ethyl ester, arginine ethyl ester, p-alanine-based diamine, and random or block copolymers made from at least one diisocyanate and at least one diol and/or diamine; see, e.g., U.S. Patent Application Publication No. 20140010858).

The concentration of the polyol, polyamine, and/or polythiol chain extender may vary depending on the resin composition and the desired properties of three-dimensional object to be formed. However, in some embodiments, added chain extender is present in the resin composition at a concentration in a range of 5 weight percent to 70 weight percent.

### Additional Resin Components

The polymerizable liquid may optionally include one or more additional components depending on the three-dimensional object being made and its intended use. Additional resin components include, but are not limited to, one or more of a reactive diluent, a non-reactive diluent, a UV absorber (e.g., a pigment and/or dye), an antioxidant, a plasticizer, a filler, a radical inhibitor, and a thermal inhibitor.

A number of possible reactive diluents may be used. A reactive diluent is a monomer or oligomer that is included in the resin composition, typically to reduce the viscosity of the resin composition and/or adjust the physical properties to the final three-dimensional object. Suitable examples of reactive diluents include, but are not limited to, an acrylate, a methacrylate (e.g., isobornyl methacrylate), N,N-dimethylacrylamide, N-vinyl-2-pyrrolidone, and N-vinyl formamide, or a mixture of two or more thereof. In some embodiments, the reactive diluent is present in the resin in an amount sufficient to reduce the viscosity to not more than 15,000, 10,000, 6,000, 5,000, 4,000, or 3,000 centipoise at 25° C. In some embodiments, the reactive diluent is present in the polymerizable liquid at a concentration in a range of from about 1%, about 5%, or about 10% by weight to about 30%, about 40%, or about 50% by weight (e.g., about 1%, about 2%, about 3%, about 4%, about 5%, about 10%, about 15%, about 20%, about 25%, about 30%, about 35%, about 40%, about 45%, about 50% by weight, or a range defined between any two of the foregoing values).

Non-reactive diluents that may be useful in some embodiments of the invention are, in general, organic liquids that can be polar or nonpolar, and protic or aprotic. In particular embodiments, the non-reactive diluent comprises an alkane (e.g., a C7-C15 alkane), a volatile silicone diluent, and/or an acetate (e.g., a C3-C25 acetate such as di(propylene glycol)methyl ether acetate and diisononyl adipate). The non-reactive diluent(s) are preferably non-flammable, non-hygroscopic, low odor, and low viscosity. In some embodiments, the non-reactive diluent has an autoignition temperature greater than about 300° C., greater than about 400° C., or greater than about 600° C. (i.e., as measured in accordance with the procedure described in ASTM E659). In some embodiments, the non-reactive diluent has a flash point of greater than about 50° C., greater than about 80° C., greater than about 100° C., or greater than about 140° C. as measured by the Pensky-Martens closed cup method (e.g., ASTM D93, EN ISO 2719, or IP 34). In some embodiments, the non-reactive diluent may be volatile (e.g., evaporates during the heating and/or moisture curing steps described herein). In some embodiments, the non-reactive diluent may act as a plasticizer.

In some embodiments, the non-reactive diluent is present in the polymerizable liquid at a concentration in a range from about 5% by weight to about 50% by weight, including in an amount of about 5% by weight to about 20% by weight. In some embodiments, the non-reactive diluent is included in the resin composition in an amount of from about 1% or about 5% by weight to about 10%, about 15% or about 20% by weight (e.g., about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19% and about 20% by weight, or a range defined between any two of the foregoing values).

In some embodiments, the resin composition includes a pigment or dye that absorbs and/or scatters light, particularly UV light. Suitable examples of such light absorbers and/or scatterers include, but are not limited to: (i) titanium dioxide (e.g., included in an amount of from about 0.001% or about 0.1% to about 1% or about 5% by weight), (ii) carbon black (e.g., included in an amount of from about 0.001% or about 0.1% to about 1% or about 5% by weight), and/or (iii) an organic ultraviolet light absorber such as a hydroxybenzophenone, hydroxyphenylbenzotriazole, oxanilide, benzophenone, thioxanthone, hydroxyphenyltriazine, benzotriazole ultraviolet light absorber (e.g., Mayzo BLS® 1326), and/or bis(1,2,2,6,6-pentamethyl-4-piperidinyl)sebacate (Tinuvin 765, BASF), and the like. Examples of suitable organic ultraviolet light absorbers include, but are not limited to, those described in U.S. Pat. Nos. 3,213,058, 6,916,867, 7,157,586, and 7,695,643. The amount of such light absorbers may vary but, in some embodiments, the polymerizable liquid includes a non-reactive pigment or dye that absorbs light at a concentration in a range of about 0.001% or about 0.005% to about 1%, about 2% or about 4% percent by weight.

A number of possible antioxidants may be used in the resin composition embodiments of the invention. Examples of antioxidants include, but are not limited to, phenols, hindered phenols (e.g., Irganox 245 by BASF), phosphites, thiosynergists, and combinations thereof (available, for example, from Mayzo, Suwanee, Ga.). The amount of antioxidant may vary but, in some embodiments, the polymerizable liquid includes an antioxidant at a concentration in a range of about 0.001% or about 0.005% to about 1% or about 2% percent by weight.

A number of possible fillers may be used in the resin composition embodiments of the invention, including, but not limited to, tougheners and/or core-shell rubbers. Any suitable filler may be used in connection with the present invention, depending on the properties desired in the part or object to be made. Thus, fillers may be solid or liquid, organic or inorganic, and may include reactive and non-reactive rubbers: siloxanes, acrylonitrile-butadiene rubbers; reactive and non-reactive thermoplastics (including but not limited to: poly(ether imides), maleimide-styrene terpolymers, polyarylates, polysulfones and polyethersulfones, etc.); inorganic fillers such as silicates (such as talc, clays, silica, mica), glass, carbon nanotubes, graphene, cellulose nanocrystals, etc., including combinations of two or more of the foregoing. Suitable fillers include tougheners, such as core-shell rubbers, as discussed below. In some embodiments, the filler is a hydrophobic or hydrophilic fumed or precipitated silica, titanium dioxide, or carbon black, and may be present in the composition at a concentration of about 5 wt % to about 30 wt % (e.g., about 10 wt % to about 20 wt %).

One or more polymeric and/or inorganic tougheners can be used as a filler in the present invention. In some embodiments, the toughener may be uniformly distributed in the form of particles in the cured product. In particular embodiments, the toughener particles are less than 5 microns in diameter. Such tougheners include, but are not limited to, those formed from elastomers, branched polymers, hyperbranched polymers, dendrimers, rubbery polymers, rubbery copolymers, block copolymers, core-shell particles, oxides or inorganic materials such as clay, polyhedral oligomeric silsesquioxanes (POSS), carbonaceous materials (e.g., carbon black, carbon nanotubes, carbon nanofibers, fullerenes), ceramics and silicon carbides, with or without surface modification or functionalization.

Core-shell rubbers are particulate materials (particles) having a rubbery core. Such materials are known and described in, for example, US Patent Application Publication No. 2015/0184039, as well as US Patent Application Publication No. 2015/0240113, and U.S. Pat. Nos. 6,861,475, 7,625,977, 7,642,316, 8,088,245, and elsewhere. In some embodiments, the core-shell rubber particles are nanoparticles (i.e., having an average particle size of less than 1000 nanometers (nm)). Generally, the average particle size of the core-shell rubber nanoparticles is less than 500 nm, e.g., less than 300 nm, less than 200 nm, less than 100 nm, or even less than 50 nm. Typically, such particles are spherical, so the particle size is the diameter; however, if the particles are not spherical, the particle size is defined as the longest dimension of the particle. Suitable core-shell rubbers include, but are not limited to, those sold by Kaneka Corporation under the designation

Kaneka Kane Ace, including the Kaneka Kane Ace 15 and 120 series of products, including Kaneka Kane Ace MX 120, Kaneka Kane Ace MX 153, Kaneka Kane Ace MX 154, Kaneka Kane Ace MX 156, Kaneka Kane Ace MX170, Kaneka Kane Ace MX 257, and Kaneka Kane Ace MX 120 core-shell rubber dispersions, and mixtures thereof.

The resin composition may include other solid particles suspended or dispersed therein. The particles can be metallic, organic/polymeric, inorganic, or composites or mixtures thereof. The particles can be nonconductive, semi-conductive, or conductive (including metallic and non- metallic or polymer conductors); and the particles can be magnetic, ferromagnetic, paramagnetic, or nonmagnetic. The particles can be of any suitable shape, including spherical, elliptical, cylindrical, etc. The particles can be of any suitable size (for example, ranging from about 1 nm to about 20 μm average diameter). The particles can comprise an active agent or detectable compound as described below, though these may also be dissolved or solubilized in the liquid resin. For example, magnetic or paramagnetic particles or nanoparticles can be employed.

Resin compositions of the invention may optionally have other ingredients solubilized therein, including active compounds or pharmaceutical compounds, detectable compounds (e.g., fluorescent, phosphorescent, radioactive), again depending upon the particular purpose of the product being fabricated. Examples of such additional ingredients include, but are not limited to, proteins, peptides, nucleic acids (DNA, RNA) such as siRNA, sugars, small organic compounds (drugs and drug-like compounds), etc., including combinations thereof.

In some embodiments, the resin composition may include a deoxygenating compound as an accelerator of stereolithography (particularly CLIP). An example of an accelerator is triphenylphosphine.

### Additive Manufacturing Methods

In some embodiments, the methods includes (a) providing a carrier and an optically transparent member having a build surface, the carrier and the build surface defining a build region therebetween; (b) filling the build region with the resin composition; (c) irradiating the build region with actinic radiation or light through the optically transparent member to solidify at least a portion of the resin composition; (d) advancing the carrier away from the build surface; (e) repeating steps (b) through (d) to form a solid polymer scaffold that is a three-dimensional intermediate having the same shape as, or a shape to be imparted to, the three-dimensional object; (f) optionally, washing the three-dimensional intermediate; and (g) further reacting the three-dimensional intermediate to form the three-dimensional object.

In some embodiments, further reacting comprises exposing the three-dimensional intermediate to heat, microwave irradiation, irradiation at a same or different wavelength than in step (c), and/or moisture. In some embodiments, the further reacting step (g) comprises heating the three-dimensional intermediate sufficient to degrade the polymer scaffold and reacting a portion of the degraded scaffold with the epoxy compound. In some embodiments, the isocyanate functional groups on the degraded scaffold react with the epoxy compound.

In some embodiments, step (c) and/or step (d) is carried out while also concurrently (i) continuously maintaining a dead zone of the resin composition in contact with the build surface; and (ii) continuously maintaining a gradient of polymerization zone between the dead zone and the solidified polymer in contact with the carrier, the gradient of polymerization zone comprising the resin composition in partially cured form.

Resin compositions, as described herein, may be used to make three-dimensional objects in an additive manufacturing process that generates a “green” or intermediate object using a first curing process (e.g., curing with UV light), followed by moisture curing of that intermediate object to form the three-dimensional object.

Techniques for additive manufacturing are known. Suitable techniques include bottom-up or top-down additive manufacturing, generally known as stereolithography. Such methods are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and U.S. Patent Application Publication No. 2013/0295212 to Chen et al.

In some embodiments, the intermediate object is formed by a continuous liquid interface production (CLIP) process. CLIP is known and described in, for example, U.S. Pat. Nos. 9,211,678, 9,205,601, 9,216,546, and in J. Tumbleston, D. Shirvanyants, N. Ermoshkin et al., Continuous liquid interface production of 3D Objects, Science 347, 1349-1352 (2015). See also R. Janusziewcz et al., Layerless fabrication with continuous liquid interface production, Proc. Natl. Acad. Sci. USA 113, 11703-11708 (2016). In some embodiments, CLIP employs features of a bottom-up three-dimensional fabrication, as described above, but the irradiating and/or said advancing steps are carried out while also concurrently maintaining a stable or persistent liquid interface between the growing object and the build surface or window, such as by: (i) continuously maintaining a dead zone of polymerizable liquid in contact with said build surface, and (ii) continuously maintaining a gradient of polymerization zone (such as an active surface) between the dead zone and the solid polymer and in contact with each thereof, the gradient of polymerization zone comprising the first component in partially-cured form.

In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. Other approaches for carrying out CLIP that can be used in the present invention and potentially obviate the need for a semipermeable “window” or window structure include utilizing a liquid interface comprising an immiscible liquid (see L. Robeson et al., WO Publication No. 2015/164234), generating oxygen as an inhibitor by electrolysis (see I. Craven et al., WO Publication No. 2016/133759), and incorporating magnetically positionable particles to which the photoactivator is coupled into the polymerizable liquid (see J. Rolland, WO Publication No. 2016/145182).

Other examples of methods and apparatus for carrying out particular embodiments of CLIP include but are not limited to U.S. Pat. No. 10,384,439; U.S. Patent Application Pub. No. US 2016/0288376; U.S. Pat. Nos. 9,782,934; 10,073,424; 10,118,377; U.S. Publication No. 2018/0243976; U.S. Pat. Nos. 11,117,316; and 10,213,956.

In some embodiments of the invention, provided are three-dimensional objects formed from a resin composition or method of the invention. In some embodiments, the three-dimensional objects include a polymer having at least one oxazolidinone linkage. In some embodiments, the polymer formed includes one or more of an ether linkage, a polyurethane linkage, a polyurea linkage, and an oxazolidinone linkage.

The present invention is further described in the following non-limiting examples.

### EXAMPLES

### Example 1

The components listed below in Table 1 were added to a container and thoroughly mixed (either by an overhead stirrer or a centrifugation mixer such as THINKY mixer) to obtain a homogeneous resin. Test specimens were produced either by flood curing in a predefined mold or with additive manufacturing processes. As defined in Table 2, samples were then either post-cured at 70° C., 95% relative humidity for 3 days, or at 140° C. for 12 hr.

TABLE 1

| | |
|---|---|
| Component | Loading (wt %) |

| | | |
|---|---|---|
| TBAEMA blocked polyisocyanate | ABPU | 61 |
| Reactive diluent | IBOMA | 30 |
| Crosslinker | CN1964 | 5 |
| Photoinitator | TPO-L | 4 |

### Example 2

The mixture from Example 1 was then mixed with bisphenol A diglycidyl ether (BADGE) at 1:1 epoxy to isocyanate molar ratio with a centrifugation mixer to obtain a homogenous resin. Test specimens were produced either by flood curing in a predefined mold or with additive manufacturing processes. Samples were then post-cured at 140° C. for 12 hr.

### Example 3

The mixture from Example 1 was then mixed with trimethylolpropane triglycidyl ether at 1:1 epoxy to isocyanate molar ratio with a centrifugation mixer to obtain a homogenous resin. Test specimens were produced either by flood curing in a predefined mold or with additive manufacturing processes. Samples were then post-cured at 140° C. for 12 hr.

### Example 4

The mixture from Example 1 was then mixed with 4,4′-methylenebis(N,N-diglycidylaniline at 1:1 epoxy to isocyanate molar ratio with a centrifugation mixer to obtain a homogenous resin. Test specimens were produced either by flood curing in a predefined mold or with additive manufacturing processes. Samples were then post-cured at 140° C. for 12 hr.

TABLE 2

| Example | 1 | 1 | 2 | 3 | 4 |
|---|---|---|---|---|---|
| Post-cure | 70° C. 95% RH | 12 hr 140° C. | 12 hr 140° C. | 12 hr 140° C. | 12 hr 140° C. |
| condition | 3 days | | | | |
| Tensile modulus | 540 | 570 | 811 | 580 | 400 |
| (MPa) | | | | | |
| Elongation at | 450 | 5 | 100 | 100 | 110 |
| break (%) | | | | | |
| Tensile strength | 7 | — | 21 | 15 | 11 |
| at yield (MPa) | | | | | |
| UTS (MPa) | 26 | 14 | 41 | 30 | 21 |
| Notched IZOD | DNB | N/A | 152 | 153 | 185 |
| (J/m) | | | | | |

As can be seen in Table 2, in Example 2, a polymer having a significantly higher modulus, tensile strength at yield, ultimate tensile strength (UTS) and Notched IZOD impact strength, relative to the ABPU-only system and the other polyfunctional epoxy compounds, was formed using the BADGE polyfunctional epoxy compound. Interestingly, increased functionality did not increase stiffness even at high strains, and optimized curing conditions or the addition of a catalyst may be needed for compounds with increased reactive functionality. This example illustrates the variety of physical properties that may be obtained using different epoxy compounds.

Importantly, the latency of this chemistry resulted in a mixed pot-life of at least 3 weeks at 60° C. To determine pot life for these mixtures, a composition in Example 2 was stored in a 20 mL scintillation vial at 60° C. and the physical state of the mixture was qualitatively observed by periodically inverting the vial. After 3 weeks at 60° C., the mixture no longer flowed.

### Example 5

The components listed below in Table 3 were added to a container and thoroughly mixed (either by an overhead stirrer or a centrifugation mixer such as THINKY mixer) to obtain a homogeneous resin. Test specimens were produced with additive manufacturing processes to generate a latticed puck for compressive testing. Samples were then post-cured at 70° C. 95% RH for 18 hr followed by a 4 hr bake at 120° C.

TABLE 3

| Component | | Loading (wt %) |
|---|---|---|
| TBAEMA blocked polyisocyanate | ABPU | 75 |
| Reactive diluents | IBOMA, | 20 |
| | LMA, | |
| Crosslinker | PEG600DMA | 2 |
| Photoinitator | TPO-L | 3 |

### Example 6

The mixture from Example 5 was then mixed with trimethylolpropane triglycidyl ether at 1:1 epoxy to isocyanate molar ratio with a centrifugation mixer to obtain a homogenous resin. Test specimens were produced with additive manufacturing processes to generate a latticed puck for compressive testing. Samples were then post-cured at 140° C. for 12 hr.

TABLE 4

| Example | 5 | 6 |
|---|---|---|
| Compressive stress at | 0.10 | 0.084 |
| 100 mm/min | | |
| (25 strain, MPa) | | |
| Compressive stress at | 0.48 | 0.61 |
| 3.46 m/s | | |
| (25 strain, MPa) | | |
| Ratio of stiffness at | 4.8 | 7.2 |
| 3.46 m/s and 100 mm/min | | |
| Compressive energy return | 54% | 36% |
| at 100 mm/min (%) | | |

As can be seen in Table 4, the addition of an epoxy increased the dynamic response of the material as evidenced by the greater stiffness at 3.46 m/s and the greater ratio of stiffness between 3.46 m/s and 100 mm/min. Additionally, the reduced energy return indicates that the reaction product of isocyanate and epoxy produces a more damping elastomer.

The foregoing is illustrative of the present invention, and is not to be construed as limiting thereof. The invention is defined by the following claims, with equivalents of the claims to be included therein.

What is claimed is:

1. A method of forming a three-dimensional object, comprising:
irradiating a resin composition with actinic radiation or light (e.g., by a top-down or bottom-up stereolithography method), thereby forming a three-dimensional intermediate, and then further reacting the three-dimensional intermediate to form the three-dimensional object,
wherein the resin composition comprises:
(a) a reactive blocked polyisocyanate;
(b) a polyfunctional epoxy compound;
(c) a photoinitiator;
(d) optionally, a catalyst;
(e) optionally, a polyol and/or a polyamine;
(f) optionally, a reactive diluent;
(g) optionally, a pigment or dye; and
(h) optionally, a filler.

2. The method of claim 1, wherein the reactive blocked polyisocyanate comprises at least one ether linkage, at least one urethane linkage, and/or at least one urea linkage.

3. The method of claim 1, wherein the reactive blocked polyisocyanate is blocked with a secondary amine or tertiary amine (e.g., a hindered secondary amine acrylate and/or hindered secondary amine methacrylate).

4. The method of claim 1, wherein the reactive blocked polyisocyanate has a formula of A—X—A, wherein X is a hydrocarbyl group and each A is independently selected from a substituent of Formula (X): 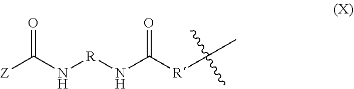
where R is a hydrocarbyl group, R′ is O or NH, and Z is a blocking group comprising a reactive epoxy, alkene, alkyne, or thiol terminal group.

5. The method of claim 1, wherein the reactive blocked polyisocyanate comprises a diisocyanate prepolymer reacted with an amine acrylate and/or an amine methacrylate (e.g., tertiary-butylaminoethyl methacrylate).

6. The method of claim 1, wherein the polyfunctional epoxy compound is an end-functionalized compound (e.g., bisphenol A diglycidyl ether, neopentyl glycol diglycidyl ether, polyethyene glycol diglycidyl ether, N,N,N′,N′-tetraglycidyl-m-xylenediamine) and/or a compound with an epoxy group within the backbone and/or pendent from a polymeric chain (e.g., novolac multifunctional epoxy, polybutadiene functionalized epoxy).

7. The method of claim 1, wherein a pigment or dye is present in the resin composition at an amount in a range of 0.001 to 10 percent by weight, optionally wherein the pigment or dye comprises titanium dioxide, carbon block and/or an organic ultraviolet light absorber.

8. The method of claim 1, wherein the reactive diluent comprises an acrylate, a methacrylate, a styrene, an acrylic acid, a vinylamide, a vinyl ether, a vinyl ester, polymers containing any one or more of the foregoing, or a combination of two or more of the foregoing.

9. The method of claim 1, wherein the method comprises:
(a) providing a carrier and an optically transparent member having a build surface, the carrier and the build surface defining a build region therebetween;
(b) filling the build region with the resin composition;
(c) irradiating the build region with actinic radiation or light through the optically transparent member to solidify at least a portion of the resin composition;
(d) advancing the carrier away from the build surface;
(e) repeating steps (b) through (d) to form a solid polymer scaffold that is a three-dimensional intermediate having the same shape as, or a shape to be imparted to, the three-dimensional object;
(f) optionally, washing the three-dimensional intermediate; and
(g) further reacting the three-dimensional intermediate to form the three-dimensional object.

10. The method of claim 9, wherein further reacting comprises exposing the three-dimensional intermediate to heat, microwave irradiation, irradiation at a same or different wavelength than in step (c), and/or moisture.

11. The method of claim 9, wherein the further reacting step (g) comprises heating the three-dimensional intermediate sufficient to degrade the polymer scaffold and reacting a portion of the degraded scaffold with the polyfunctional epoxy compound.

12. The method of claim 11, wherein isocyanate functional groups on the degraded scaffold react with the polyfunctional epoxy compound.

13. The method of claim 9, wherein step (c) and/or step (d) is carried out while also concurrently (i) continuously maintaining a dead zone of the resin composition in contact with the build surface; and (ii) continuously maintaining a gradient of polymerization zone between the dead zone and the solidified polymer in contact with the carrier, the gradient of polymerization zone comprising the resin composition in partially cured form.

14. The method of claim 13, wherein the optically transparent member comprises a semipermeable member (optionally wherein the semipermeable member comprises a fluoropolymer), and continuously maintaining a dead zone is carried out by feeding an inhibitor (e.g., oxygen) through said optionally transparent member (optionally creating a gradient of inhibitor in the dead zone and optionally in at least a portion of the gradient of polymerization zone).

15. A method of forming a three-dimensional object, comprising:
irradiating a resin composition with actinic radiation or light (e.g., by a top-down or bottom-up stereolithography method), thereby forming a three-dimensional intermediate, and then further reacting the three-dimensional intermediate to form the three-dimensional object,
wherein the resin composition comprises:
(i) a polyisocyanate;
(ii) a polyfunctional epoxy compound;
(iii) a photoinitiator;
(iv) a catalyst;
(v) optionally, a polyol and/or a polyamine;
(vi) optionally, a reactive diluent;
(vii) optionally, a pigment or dye; and
(viii) optionally, a filler.

16. The method of claim 15, wherein the polyisocyanate comprises at least one ether linkage, at least one urethane linkage, and/or at least one urea linkage.

17. The method of claim 15, wherein the resin composition includes a reactive diluent and the reactive diluent solidifies upon the irradiation to form the three-dimensional intermediate.

18. The method of claim 15, wherein the polyfunctional epoxy compound is an end-functionalized compound (e.g., bisphenol A diglycidyl ether, neopentyl glycol diglycidyl ether, polyethyene glycol diglycidyl ether, N,N,N′,N′-tetraglycidyl-m-xylenediamine) and/or a compound with an epoxy group within the backbone and/or pendent from a polymeric chain (e.g., novolac multifunctional epoxy, polybutadiene functionalized epoxy).

19. The method of claim 15, wherein a pigment or dye is present in the resin composition at an amount in a range of 0.001 to 10 percent by weight, optionally wherein the pigment or dye comprises titanium dioxide, carbon block and/or an organic ultraviolet light absorber.

20. The method of claim 15, wherein the reactive diluent comprises an acrylate, a methacrylate, a styrene, an acrylic acid, a vinylamide, a vinyl ether, a vinyl ester, polymers containing any one or more of the foregoing, and combinations of two or more of the foregoing.

21. The method of claim 15, wherein the method comprises:
(a) providing a carrier and an optically transparent member having a build surface, the carrier and the build surface defining a build region therebetween;
(b) filling the build region with the resin composition;
(c) irradiating the build region with actinic radiation or light through the optically transparent member to solidify at least a portion of the resin composition;
(d) advancing the carrier away from the build surface;
(e) repeating steps (b) through (d) to form a solid polymer scaffold that is a three-dimensional intermediate having the same shape as, or a shape to be imparted to, the three-dimensional object;
(f) optionally, washing the three-dimensional intermediate; and
(g) further reacting the three-dimensional intermediate to form the three-dimensional object.

22. The method of claim 21, wherein further reacting comprises exposing the three-dimensional intermediate to heat, microwave irradiation, irradiation at a same or different wavelength than in step (c), and/or moisture.

23. A three-dimensional object formed by the method of claim 1.
